(19) United States
(12) Patent Application Publication
(10) Pub. No.: US 2010/0315331 A1
(43) Pub. Date: Dec. 16, 2010

(54) DISPLAY DEVICE AND DISPLAY CONTROL METHOD THEREOF

(75) Inventors: MING-TESUNG CHENG, Tu-Cheng (TW); LI-ZHANG HUANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/610,351

(22) Filed: Nov. 2, 2009

(30) Foreign Application Priority Data
Jun. 16, 2009 (CN) 200910303292.5

(51) Int. Cl. G09G 5/00

(52) U.S. Cl. 345/156

(57) ABSTRACT

This present disclosure provides a display device and display control method thereof. The display method used in an interactive display system which is made up of several display devices, the method includes: establishing an interactive display system; performing interactive display in the interactive display system; deletion the interactive display system when the interactive display is ended.

### BACKGROUND

1. Technical Field

The present disclosure relates to a display device and a display control method thereof.

2. Description of Related Art

Display devices (e.g., digital photo frames) have many functions, such as, displaying images, communicating with other electronic devices, and so on. However, there is no function for interaction among these display devices.

### BRIEF DESCRIPTION OF THE DRAWINGS

The components in the drawings are not necessarily drawn to scale, the emphasis instead being placed upon clearly illustrating the principles of the display device. Moreover, in the drawings, like reference numerals designate corresponding parts throughout the several views.

FIG. 1 is a schematic diagram of an interactive display system, including multiple display devices, in accordance with an exemplary embodiment.

FIG. 2 is a block diagram of hardware infrastructure of the display devices of FIG. 1, in accordance with an exemplary embodiment.

FIG. 3 is a block diagram showing main function modules of a central processing unit (CPU) of one of the display devices in FIG. 2.

FIG. 4 is a flowchart of an interactive display method implemented by the system of FIG. 1, in accordance with an exemplary embodiment.

FIG. 5 is a detailed flowchart of the interactive display method, in accordance with an exemplary embodiment.

### DETAILED DESCRIPTION

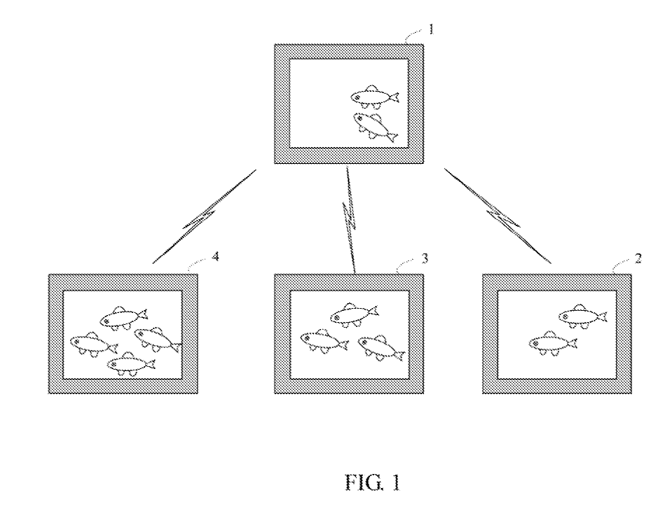

FIG. 1 is a schematic diagram of an interactive display system, including multiple display devices, in accordance with an exemplary embodiment. The interactive display system includes at lease two display devices. As shown in FIG. 1, four display devices 1-4 are taken for example. The display device that establishes the interactive display system is regarded as an administrator; other display devices that join in the interactive display system are regarded as members. Take display device 1 as the administrator in the interactive display system for example, the display device 1 establishes the interactive display system and sends control signals to the display devices 2-4 to perform the interactive display. For example, when the display device 1 sends a display signal of “displaying swimming fish” to the display devices 2-4 one by one, the fish will look like swimming among these display devices 1-4. The display devices 1-4 may be digital photo frames or other electronic devices.

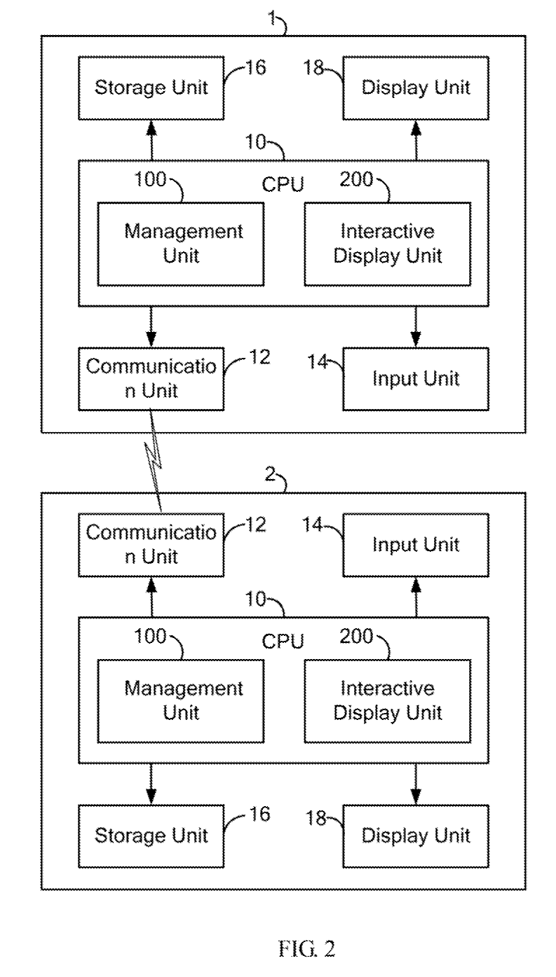

FIG. 2 is a block diagram of hardware infrastructure of the display devices of FIG. 1, in accordance with an exemplary embodiment. The display devices 1-4 have the same physical structures, so, for simple description, only display device 1 is taken for example in the following disclosure.

The display device 1 includes a CPU 10, a communication unit 12, an input unit 14, a storage unit 16, and a display unit 18. The CPU 10 is configured to generate control signals to establish the interactive display system and perform the interactive display among the display devices 1-4. The communication unit 12 is configured to communicate with external devices (e.g., the display devices 2-4). The communication unit 12 may be a wireless communications unit, such as a BLUETOOTH device, and may further be a wired communications unit, such as that based on RS232 standard. The input unit 14 is configured to generate signals in response to user inputs. The storage unit 16 is configured to provide space for storing data. The data include, but not limited to, images, text, video files, and names, paths or other attribute of the above files. The display unit 18 is configured to display the data.

The CPU 10 includes a management unit 100 and an interactive display unit 200. The management unit 100 is configured to select one or more external display devices to join in the interactive display system. The management unit 100 is further configured to delete members in the interactive display system. The interactive display unit 200 is configured to control members to perform an interactive display in turn or at random, and determine whether the interactive display is ended.

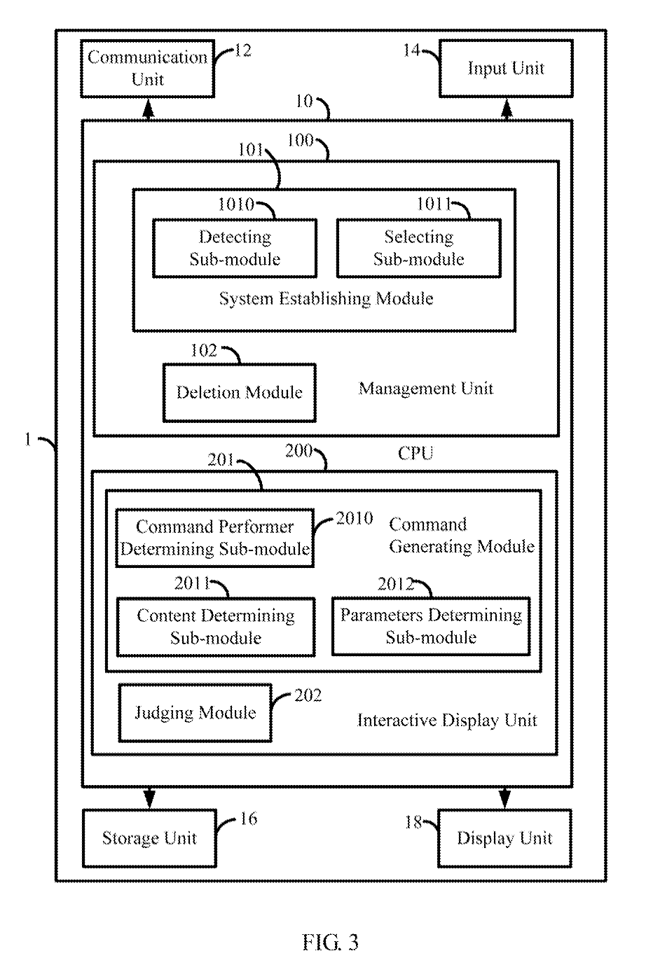

FIG. 3 is a block diagram showing main function modules of a central processing unit (CPU) of one of the display devices in FIG. 2. The management unit 100 includes a system establishing module 101 and a deletion module 102. The system establishing module 101 is configured to select one or more display devices to establish an interactive display system. The deletion module 102 is configured to delete the display devices from the system when the interactive display is ended.

Each display device is corresponding to a unique identifier (ID). The system establishing module 101 detects the IDs of the available display devices connected in a network, and adds a plurality of IDs to a record (e.g., a table), which is saved in the storage unit 16. The deletion module 102 deletes the IDs from the record when the interactive display is ended.

The interactive display unit 200 includes a command generating module 201 and a judging module 202. The command generating module 201 is configured to generate commands, which includes IDs of the display devices, information of display content, display parameters, and so on. The command generating modules 201 is further configured to send the commands to the members that have corresponding IDs. The judging module 202 is configured to determine whether the interactive display is ended, and is further configured to determine whether there is a next display device to perform the interactive display when the interactive display is not ended. There are two determining modes applied by the judging module 202 to determine whether the interactive display is ended. One determining mode is determining whether there is a next member to perform the interactive display command according to the IDs stored in the record, that is, determining whether there is a next ID stored in the record. The other determining mode is determining when a current time reaches a predetermined time (e.g., 18: 38: 08) regarded as the interactive display is ended.

The system establishing module 101 includes a detecting sub-module 1010 and a selecting sub-module 1011. The detecting sub-module 1010 is configured to detect available external display devices through the communication unit 12, and obtain the external display devices' IDs. The selecting sub-module 1011 is configured to select external display devices' IDs to establish the interactive display system. There are two selecting modes applied by the selecting sub-module 1011. One selecting mode is selecting all of the available IDs. The other selecting mode is random selecting a part of the available IDs.

The command generating module 201 includes a command performer determining sub-module 2010, a content determining sub-module 2011, and a parameters determining sub-module 2012.

The command performer determining sub-module 2010 is configured to determine which display device is to perform the current command that sent from the display device 1 according to the IDs stored in the record. For example, in a first exemplary embodiment, the command performer determining sub-module 2010 serially obtains an ID from the record and determines the display device corresponding to the obtained ID as the current display device to perform the current command. In a second exemplary embodiment, the command performer determining sub-module 2010 randomly selects an ID from the record and determines the display device corresponding to the obtained ID as the current display device to perform the current command.

The content determining sub-module 2011 is configured to determine information (e.g., name or path) of the current display content to be displayed on the current display device to perform the current command. The determined information is used to guide the current display device to obtain the display content.

The parameters determining sub-module 2012 is configured to determine display parameters of the current content. The display parameters include, but not limited to, display speed, display effect, and so on. For example, the display speed is 60 frames per second and the display effect is flying into from right. In another exemplary embodiment, the parameters determining sub-module 2012 is further configured to determine display starting time of the current display content. For example, the display starting time is 18: 36: 02.

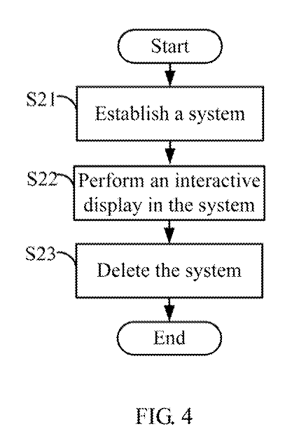

FIG. 4 is a flowchart of an interactive display method implemented by the system of FIG. 1, in accordance with an exemplary embodiment. In step S21, the system establishing module 101 establishes an interactive display system. In step S22, the command generating module 201 generates and sends commands to perform the interactive display. In step S23, the deletion module 102 deletes the interactive display system when the judging module 202 determines the interactive display is ended.

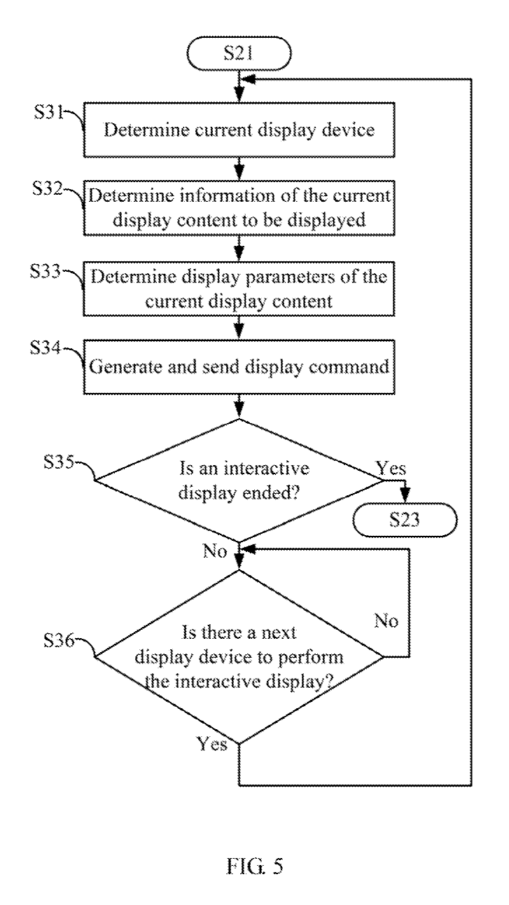

FIG. 5 is a detailed flowchart of interactive display method, in accordance with an exemplary embodiment. In step S31, the command performer determining sub-module 2010 determines the current display device to perform the current command. In step S32, the content determining sub-module 2011 determines information of the current display content to be displayed on the determined display device. In step S33, the parameters determining sub-module 2012 determines display parameters of the current display content. In step S34, the command generating module 201 generates and sends the command to the determined display device, wherein the command includes the current display device's ID, information of the current display content, and the display parameters. In step S35, the judging module 202 determines whether the interactive display is ended. If the interactive display is ended, the process goes to S36, if the interactive display is not ended, the process return to S23. In step S36, the judging module 202 determines whether there is a next display device to perform the interactive display. If no, the process repeats S36; if yes, the process returns to S31.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the disclosure.

What is claimed is:

1. A display device comprising:
a system establishing module configured to select one or more display devices to establish an interactive display system;
an interactive display unit configured to control display devices in the interactive display system to perform an interactive display in turn or at random, and determine whether the interactive display is ended; and
a deletion module configured to delete the display devices when the interactive display is ended.

2. The display device as described in claim 1, wherein the interactive display unit comprises:
a command performer determining sub-module configured to determine current interactive display device by selecting in turn or at random;
a content determining sub-module configured to determine information of current display content to be displayed on the current display device to perform the current command;
a parameters determining sub-module configured to determine display parameters of the current content and display starting time of the current display content;
a judging module configured to determine whether the interactive display is ended, and further configured to determine whether there is a next display device to perform the interactive display when the interactive display is not ended.

3. The display device as described in claim 1, wherein the system establishing module comprises a detecting sub-module, configured to detect available external display devices through a communication unit, and obtain the external display devices' IDs; and further comprises a selecting sub-module, configured to select external display devices' IDs to establish the interactive display system.

4. The display device as described in claim 1, wherein the judging module determines there is not a next member to perform the interactive display command regarded as the interactive display is ended.

5. The display device as described in claim 1, wherein the judging module determines when a current time reaches a predetermined time regarded as the interactive display is ended.

6. An interactive display system comprising:
a administrator configured to establish an interactive display system and control an interactive display in an interactive display system;
several members configured to join in the interactive display system and perform the interactive display.

7. The interactive display system as described in claim 6, wherein the administrator and members in the interactive display system have same physical structures, the administrator comprises:
a system establishing module configured to select one or more display devices to establish an interactive display system;
an interactive display unit configured to control display devices in the interactive display system to perform an interactive display in turn or at random, and determine whether the interactive display is ended; and
a deletion module configured to delete the display devices when the interactive display is ended.

8. The interactive display system as described in claim 6, wherein the interactive display unit comprises:
a command performer determining sub-module configured to determine current interactive display device by selecting in turn or at random;
a content determining sub-module configured to determine information of current display content to be displayed on the current display device to perform the current command;
a parameters determining sub-module configured to determine display parameters of the current content and display starting time of the current display content;
a judging module configured to determine whether the interactive display is ended, and further configured to determine whether there is a next display device to perform the interactive display when the interactive display is not ended.

9. A display control method used in an interactive display system, the method comprising:
selecting available display devices and establishing an interactive display system;
performing an interactive display in the interactive display system;
deleting the interactive display system when the interactive display is ended.

10. The method as described in claim 9, the step of performing interactive display further comprising:
determining current interactive display device to perform the current command;
determining information of the current display content on the determined display device;
determining display parameters of the current display content;
generating and sending display commands which include the display device's ID, information of current display content and the display parameters to the determined display device.

11. The method as described in claim 9, the step of performing interactive display further comprising:
determining whether the interactive display is ended;
determining whether there is a next display device to perform the interactive display when the interactive display is not ended;
performing interactive display in the interactive display system when there is a next display device to perform the interactive display.
